(19) United States
(12) Patent Application Publication
(10) Pub. No.: US 2009/0121845 A1
(43) Pub. Date: May 14, 2009

(54) COMMUNICATION SYSTEM COMPRISING A POWERLINE COMMUNICATION NETWORK AND AT LEAST ONE OTHER COMMUNICATION NETWORK, CORRESPONDING NODE

(75) Inventors: Stephane Juillot, Orleans (FR); Thierry Allard, Orleans (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: Wirecom Technologies, Orleans (FR)

(21) Appl. No.: 11/914,630

(22) PCT Filed: Apr. 20, 2006
(86) PCT No.: PCT/EP2006/061691

§ 371 Date: Jun. 3, 2008

(30) Foreign Application Priority Data
May 23, 2005 (FR) 0505160

(51) Int. Cl. G05B 11/01

(52) U.S. Cl. 340/310.11

(57) ABSTRACT

A communication system is provided, which includes a first powerline communication network via which a plurality of nodes can communicate with one another. Each node includes: a first communication interface, which interfaces the node with the first communication network and implements a first powerline communication protocol, and a component, which controls at least one equipment connected to the node. At least one of the nodes, called a gateway node, further includes: a second communication interface, which interfaces the gateway node with at least a second communication network and implements a second communication protocol, and at least one service provider, which provides at least one service to a terminal connected to the gateway node via the at least one second communication network and the second interface.

### CROSS-REFERENCE TO RELATED APPLICATIONS

This Application is a Section 371 National Stage Application of International Application No. PCT/EP2006/061691, filed Apr. 20, 2006 and published as WO 2006/125701 A1 on Nov. 30, 2006, not in English.

### FIELD OF THE DISCLOSURE

The field of the disclosure is that of systems including powerline communication networks, also called PLC networks (for “PowerLine Carrier”), which allows the wiring in an electrical network to be used to carry computer data.

Traditionally, each node is a machine, which handles one or more pieces of equipment that it controls by means of logic or analogue input/output. All of the nodes associated on a single network communicate via low-speed powerline carrier, by using for example the LonTalk protocol (registered trademark), or via high-speed powerline carrier, by using for example a protocol encapsulated in TCP/IP. The nodes are constituted by a set of interconnected electronic cards.

More precisely, the disclosure relates to a communication system including a first powerline communication network connected to at least one second communication network. In other words, the disclosure relates to a technique making it possible to open the first powerline communication network to the outside.

The disclosure has many applications, such as for example: centralized technical management, technical building management, controlling/commanding industrial and tertiary applications, building and home automation.

More generally, it can apply in all cases where one or more services relating to the first powerline communication network must be accessible from a terminal connected to the second communication network (for example the STN network or an Ethernet network).

These services are for example (non exhaustive list): a node configuration service, a configuration service of the first powerline communication network, a service to access data stored in the nodes, an archive service of data in the nodes and a node synchronization service.

### BACKGROUND OF THE DISCLOSURE

Traditionally, a control/command system includes a first powerline communication network (for example a field bus), via which a plurality of powerline carrier nodes (automatons) can communicate with each other.

For the configuration of the automatons, their management on the bus, or for access to data, a specific terminal, referred to hereinafter as control/command terminal, is today indispensable. This control/command terminal can be a portable device sold by the automaton manufacturer and which can interface with the same field bus or directly with the automatons. This can also be a computer equipped with software sold by the manufacturer of the automatons, which interfaces with the field bus or directly with the automatons and which for this may require a specific interface card.

In relation to the opening of the first powerline communication network to the outside, in such a way that the control/command terminal can be connected to the second network (and no longer to the first network), several solutions can be considered:
a hardware gateway can be installed to provide the interface to a second network (different physical medium and/or other different communication protocol). This hardware gateway is then specific to the manufacturers of the automatons;
a software gateway, implemented in the form of a computer running specific software, can also be used as the interface to a second network. In this case, the computer is connected to the same field bus as the automatons, via a specific card depending on the field bus and the chosen protocol. The specific software may or may not offer standard interfaces to allow access to the data of the automatons from the control/command terminal connected to the second network. One of the standards that is being used more and more often is the OPC interface (for “OLE for Process Control”) which defines a data exchange standard in the Windows (registered trademark) environments.

A first inconvenience with the aforementioned prior art is that the opening of the first powerline communication network to the outside world entails adding proprietary hardware and software, regardless of whether the gateway is of the hardware or of the software type.

Another inconvenience with the aforementioned prior art is that the extension of the first powerline communication network (adding one or several nodes) requires the gateway software and/or hardware to be reconfigured, when the first network is not at the limit of its capacity, or the addition of an additional gateway, when the first network is at the limit of its capacity.

Yet another inconvenience with the aforementioned prior art is that the gateway constitutes a localized point of access (physically). This is a constraint since this means that the terminals have to be connected, via the second network, to a gateway located in a particular location.

Another inconvenience with the aforementioned prior art is that the gateway constitutes a centralized point of access, which constitutes a bottleneck in terms of communication between the first and at least one second network. The prior art therefore does not provide good resistance to gateway breakdowns, nor breakdowns of the first or second network.

### SUMMARY

An illustrative example of the disclosure relates to a communication system including a first powerline communication network via which a plurality of nodes can communicate with each other, each node including:
first means of communication interface, making it possible to interface the node with the first communication network and implementing a first communication protocol by powerline carrier, and
means of control of at least one piece of equipment connected to the node.

According to the invention, at least one of the nodes, called a gateway node, further comprises:
second means of communication interface, making it possible to interface the gateway node with at least one second communication network and implementing a second communication protocol, and
at least one means of providing services, making it possible to provide at least one service to a terminal connected to the gateway node via said at least one second communication network and said second means of interface.

The general principle of an exemplary embodiment of the invention thus consists in incorporating in at least one node on one hand the functionalities of a gateway (second means of interface) and on the other hand the means of providing services.

As such, an embodiment of the invention is based on an entirely new and inventive approach of opening a first powerline communication network to at least one second communication network. This approach goes against the prejudice of those skilled in the art in which the nodes and the gateways are two distinct types of equipment, that nothing encourages a combination thereof.

An embodiment of the invention allows a terminal (computer, personal assistant (PDA), cellular telephone, etc.) to connect directly to a gateway node (and thus indirectly to all of the nodes), without going through special gateway equipment.

Moreover, an embodiment of the invention makes it possible to add as many gateway nodes as the user wishes, without requiring the resizing of any such device.

An embodiment of the invention also makes it possible to minimize the cost of the system, in particular due to the fact that the gateway node can include a single processor, which replaces the processor included in a traditional node and that included in a traditional gateway.

Preferably, the system includes at least two gateway nodes.

In a particular embodiment, it can even be provided that all of the nodes are gateway nodes.

Several advantages stem from the plurality of gateway nodes.

First of all, there are in this way, for the terminals, several access points to the first powerline communication network. These various points of access can be located in different locations. Moreover, this allows good resistance to breakdowns to be offered: if one of the gateway nodes breaks down, it is highly likely that a terminal will be able to access the first network via another gateway node.

Furthermore, if the number of gateway nodes is large enough, a sufficiently-large redundancy is obtained between the first and second communication networks in order to offer good resistance to breakdowns of the first and/or second network.

Finally, the manufacture of the gateway node in large quantities makes it possible to reduce its unit cost. As such, the production cost of N gateway nodes according to an embodiment of the invention becomes lower than the production cost of N−1 traditional nodes and a traditional gateway.

Advantageously, said at least one service belongs to the group including: a node configuration service, a management service of the first powerline communication network, a service to access the data stored in the nodes, an archive service for the data in the nodes and a node synchronization service. This list is not exhaustive.

Preferably, each gateway node includes at least one means of providing services, making it possible to provide at least the following services: a node configuration service, a configuration service of the first powerline communication network and a service to access the data stored in the nodes.

Advantageously, the second means of communication interface belong to the group including: interface means of the Ethernet type, interface means of the modem type, interface means of the infrared type, interface means of the radiofrequency type and interface means of the powerline carrier type. This list is not exhaustive.

Advantageously, said at least one means of providing services belong to the group including: Web servers, Web services, OPC servers and message managers. This list is not exhaustive.

As such, the services are offered thanks to one or several means that are well known in themselves and commonplace. Consequently, it is sufficient for the terminal (user equipment connected to the gateway node via the second network) to implement the software tool associated with this or these means (for example a Web browser if the gateway node incorporates a Web server or Web services). The operating system implemented on the terminal is of no importance.

According to an advantageous characteristic, the same means of providing services provides at least two services.

As such, realization of each gateway node is optimized.

In a first particular embodiment of the invention, said first communication network and said at least one second communication network are merged and use a same physical medium.

In this first embodiment, each network implements a distinct communication protocol (for example low-speed PLC for the first network and high-speed PLC for the second network).

In a second particular embodiment of the invention, said first communication network and said at least one second communication network are not merged and use distinct physical media.

Advantageously, in the case where each node includes means of data storage, and where the first means of communication interface include first means of reading the data stored in said means of data storage, while the second means of communication interface include second means of reading the data stored in said means of data storage.

In this way, a terminal can directly access the data of a gateway node, solely via the second network and therefore without going through the first powerline communication network. Note that this is impossible with the technique of the aforementioned prior art, wherein the terminal communicates with the gateway via the second network and the gateway communicates with the node via the first network. An embodiment of the invention thus makes it possible to limit the processing time for accessing data, as well as the risk of error.

Advantageously, each gateway node includes means of accessing data stored in another gateway node, the means of access themselves including means of selecting the first or second means of communication interface.

In this way, the best path between the given gateway node and another gateway node is chosen (each path belonging to one of the first and second networks).

An embodiment of the invention also relates to a node of the type included in a communication system including a first powerline communication network via which a plurality of nodes can communicate with each other, the node including:
first means of communication interface, making it possible to interface the node with the first communication network and implementing a first communication protocol by powerline carrier, and
means of control of at least one piece of equipment connected to the node.

According to an embodiment of the invention, the node further comprises:
second means of communication interface, making it possible to interface the node, called gateway node, with at least one second communication network and implementing a second communication protocol, and at least one means of providing services, making it possible to provide at least one service to a terminal connected to the gateway node via said at least one second communication network and said second means of interface.

### BRIEF DESCRIPTION OF THE DRAWINGS

Other characteristics and advantages shall appear when reading the description according to a preferred embodiment of the invention, by way of example and non-exhaustive, and of the annexed drawings, wherein:

FIG. 1 shows a block diagram of a particular embodiment of the system;

FIG. 2 shows a block diagram of the hardware architecture of a particular embodiment of the gateway node; and

FIG. 3 shows a block diagram of the software architecture of a particular embodiment of the gateway node.

### DETAILED DESCRIPTION OF ILLUSTRATIVE EMBODIMENTS

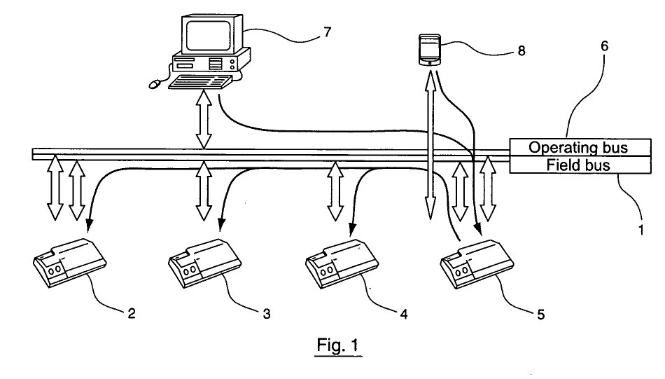

As shown in FIG. 1, an embodiment of the invention therefore relates to a communication system including a first powerline communication network (referenced 1) connected to at least one second communication network (referenced 6).

In a traditional manner, the first powerline communication network 1 is for example a field bus to which are connected a plurality of nodes, referenced 2 to 5. Each node includes first means of communication interface, making it possible to interface the node with the first communication network 1 and implementing a first powerline communication protocol (the communication between nodes uses for example the LonTalk or TCP/IP protocol). Each node also includes means of control of at least one equipment (not shown) connected to this node.

According to an embodiment of the invention, at least one of nodes 2 to 5 is a gateway node. In the rest of the description, it is considered by way of example that nodes referenced 2 and 5 are gateway nodes (and therefore that nodes referenced 3 and 4 are traditional nodes). It is clear however that an embodiment of the invention also applies in the case where there is only one gateway node or in the case where all of the nodes are gateway nodes.

Each gateway node 2, 5 includes, other than the aforementioned means included in each node, second means of communication interface, making it possible to interface the gateway node with the second communication network 6 (for example an operating bus) and implementing a second communication protocol (for example the TCP/IP or IrDA protocol). These second means of communication interface implement for example standard communication interfaces such as Ethernet, Modem (RTC, ADSL, GPRS, etc), Infrared, Radiofrequency and powerline carrier (high speed).

The first and second networks (field bus and operating bus) 1 and 6 can be merged and use the same physical medium (low-speed powerline carrier for the first and high speed for the second). According to an alternative, they are separated (for example powerline carrier for the first and Ethernet for the second). This results in the advantage of being able to use the most suitable medium according to the topology of the bus to be realised.

Each gateway node 2, 5 also includes means for providing services to a terminal connected to gateway node 2, 5 via the second communication network 6 and second means of interface.

Any type of terminal can be considered: desktop or portable computer 7, personal assistant (PDA) 8, cellular telephone (not shown), etc.

The means of providing services include for example one or more of the following standard software: Web servers, Web services, OPC servers and message managers (electronic mail (email), short messages (SMS) or others)).

The services offered (also called functions) are for example as follows:
a node configuration service;
a management service of the first powerline communication network;
a service to access data stored in the nodes;
an archive service of data in the nodes;
a node synchronization service;
etc.

We shall now cover in more detail examples of implementing the first three aforementioned functions (node configuration, management of the first network and data access).

The node configuration function is for example fulfilled by the intermediary of an integrated Web server or Web service. It is then necessary for the user only to have any Internet browser, implemented on any such terminal (portable computer, PDA, cellular telephone, etc.). The operating system implemented on the user's terminal is of no importance, it can be of the Windows (registered trademark), PalmOS (registered trademark), Unix (registered trademark) or Linux (registered trademark) type. The physical connection medium can be chosen from among Ethernet, Infrared, radiofrequency or high-speed powerline carrier (PLC). When adding additional function by extending the network, the new nodes are detected automatically and do not require a complete reconfiguration of the network. The standard tool making it possible to configure the nodes is the Web server incorporated into the node serving for the configuration. For the development of specific configuration applications, developers will use the Web services.

The function of network management and configuration of the proposed services is for example also fulfilled by the intermediary of the incorporated Web server or the aforementioned Web services. It allows nodes to be added or removed from the network.

The function of accessing node data is for example also fulfilled by the intermediary of the aforementioned incorporated Web server, associated to a CGI engine (“Common Gateway Interface”), with the purpose of data consultation by a user. In the case where this data is used by third-party software or equipment, the standard incorporated OPC interface or the Web services will be used.

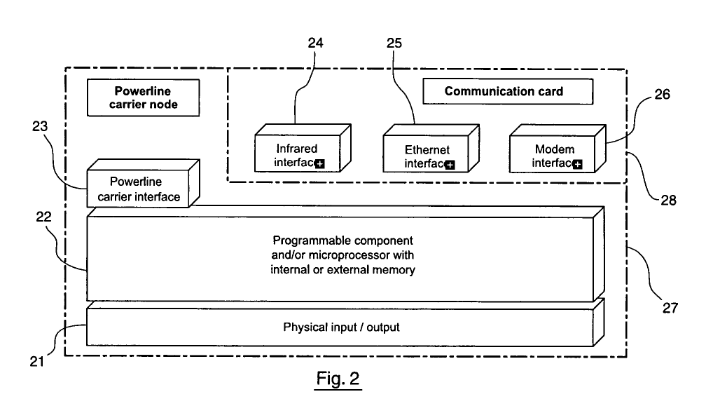

We shall now present, in relation to FIG. 2, the hardware architecture of a particular embodiment of the gateway node according to an embodiment of the invention.

As with a traditional node, the hardware architecture includes for example a first electronic card 27 (“powerline carried node card”) including:
an interface 21 to the physical input/output;
a programmable component (microcontroller or microprocessor) 22 providing the management of the input/output and the communication functions;
a non-volatile memory (not shown) in order to provide the archive functions;
an external power supply (not shown);
a backup power supply (battery) (not shown);
a real-time clock (not shown).

According to an embodiment of the invention, the hardware architecture includes for example a second electronic card 28 (“communication card”) including communication interfaces of the powerline carrier 23, infrared 24, Ethernet 25 and modem 26 type.

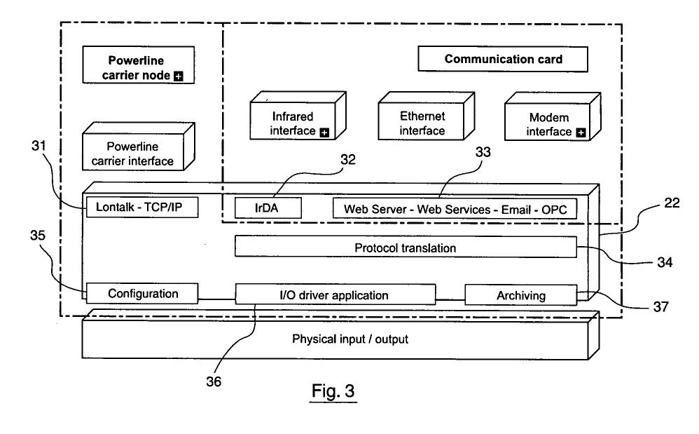

We shall now present, in relation to FIG. 3, the software architecture of a particular embodiment of the gateway node according to an embodiment of the invention.

Within the programmable component (microcontroller or microprocessor) 22, which provides operation for the core of the system, the software architecture includes:
a module 31 implementing the LonTalk and TCP/IP protocols;
a module 32 implementing the IrDA protocol;
a module 33 implementing a Web server and/or Web services and or a message manager (Email, SMS, etc.) and/or an OPC server;
a module 34 for protocol translation (gateway functions between the various protocols);
a module 36 for a driver application for the input/output;
a module 37 for archiving.

At least one example of the present disclosure provides a technique making it possible to open a first powerline communication network to at least one second communication network, this technique being simple to implement and inexpensive.

At least one example provides a technique that does not require any special gateway equipment.

At least one example provides a technique that does not require any resizing in the case of connecting a new node to the first powerline communication network.

At least one example provides such a technique that does not have a localized and centralized point of access to access the first powerline communication network.

Although the present disclosure has been described with reference to one or more examples, workers skilled in the art will recognize that changes may be made in form and detail without departing from the scope of the disclosure and/or the appended claims.

1. A communication system including a first powerline communication network via which a plurality of nodes can communicate with each other, each node comprising:
a first communication interface, making it possible to interface the node with the first communication network and implementing a first powerline communication protocol, and
a control component, which controls at least one equipment connected to the node,
wherein at least one of the nodes, called a gateway node, further comprises:
a second communication interface, making it possible to interface the gateway node with at least one second communication network and implementing a second communication protocol, and
at least one service provider, making it possible to provide at least one service to a terminal connected to the gateway node via said at least one second communication network and said second interface.

2. The communication system according to claim 1, wherein the system includes at least two of the gateway nodes.

3. The communication system according to claim 1, wherein said at least one service belongs to the group including:
a node configuration service;
a management service of the first powerline communication network;
a service to access the data stored in the nodes;
an archive service of data in the nodes; and
a node synchronisation service.

4. The communication system according to claim 1, wherein the at least one service provider of each gateway node provides at least the following services:
a node configuration service;
a configuration service of the first powerline communication network; and
a service to access data stored in the nodes.

5. The communication system according to claim 1, wherein the second communication interface belongs to the group including:
an Ethernet interface;
a modem interface;
an infrared interface;
a radiofrequency interface; and
a powerline carrier interface.

6. The communication system according to claim 1, wherein said at least one service provider belongs to the group including:
Web servers;
Web services;
OPC servers; and
message managers.

7. The communication system according to claim 1, wherein a same service provider provides at least two services.

8. The communication system according to claim 1, wherein said first communication network and said at least one second communication network are merged and use a same physical medium.

9. The communication system according to claim 1, wherein said first communication network and said at least one second communication network are not merged and use distinct physical media.

10. The communication system according to claim 1, each node including data storage, the first communication interface including first means of reading data stored in said data storage, the second communication interface including second means of reading data stored in said data storage.

11. The communication system according to claim 2, wherein each gateway node includes means to access data stored in another gateway node, the means of access themselves including means of selecting the first or second communication interface.

12. A node included in a communication system including a first powerline communication network via which a plurality of nodes can communicate with each other, the node comprising:
first means of communication interface, for interfacing the node with the first communication network and implementing a first powerline communication protocol, and
means for controlling at least one equipment connected to the node,
wherein the node further comprises:
second means of communication interface, for interfacing the node, called a gateway node, with at least one second communication network and implementing a second communication protocol, and
at least one means for providing services, making it possible to provide at least one service to a terminal connected to the gateway node via said at least one second communication network and said second means of interface.

13. A node included in a communication system including a first powerline communication network via which a plurality of nodes can communicate with each other, the node comprising:
a first communication interface, which interfaces the node with the first communication network and implements a first powerline communication protocol,
a programmable component, which controls at least one equipment connected to the node,
second communication interface, which interfaces the node, called a gateway node, with at least one second communication network and implements a second communication protocol, and
at least one service provider, which provides at least one software service to a terminal connected to the gateway node via said at least one second communication network and said second interface.
